(19) United States
(12) Patent Application Publication
(10) Pub. No.: US 2019/0120183 A1
(43) Pub. Date: Apr. 25, 2019

(54) HEAT SOURCE IN COLD VEHICLE CONDITIONS

(71) Applicant: GM GLOBAL TECHNOLOGY OPERATIONS LLC, Detroit, MI (US)

(72) Inventor: Riccardo Baria, Bruino (IT)

(73) Assignee: GM GLOBAL TECHNOLOGY OPERATIONS LLC, Detroit, MI (US)

(21) Appl. No.: 15/792,358

(22) Filed: Oct. 24, 2017

(51) Int. Cl. F02M 31/04; F02M 26/33; F02B 29/04

(52) U.S. Cl. CPC F02M 31/042; F02B 29/0493; F02M 26/33

(57) ABSTRACT

Methods and apparatuses are provided for operating an internal combustion engine of a vehicle. The internal combustion engine includes an exhaust gas system having an air intake pipe configured to direct flow of air to an internal combustion engine and an exhaust pipe configured to direct flow of an exhaust gas from the internal combustion engine. The exhaust gas system also has an exhaust gas recirculation circuit to direct at least a portion of the flow of the exhaust gas from the exhaust pipe to the air intake pipe. A stimulus is generated via an event associated with an increased risk of condensation of exhaust gas constituents in an exhaust gas recirculation cooler. Heat is supplied to at least one of the air intake pipe, the exhaust pipe, or the exhaust gas recirculation circuit in response to the stimulus.

### TECHNICAL FIELD

The present disclosure generally relates to vehicle exhaust gas systems, and, more particularly, to vehicle exhaust gas systems which include an exhaust gas recirculation circuit.

### BACKGROUND

This section provides background information related to the present disclosure which is not necessarily prior art.

An internal combustion engine conventionally includes an engine block with at least one cylinder. Each cylinder accommodates a piston, which is connected to a crankshaft via a connecting rod and, in conjunction with a cylinder head, defines a combustion chamber. A mixture of air received from an air intake pipe and fuel is introduced into the combustion chamber and ignited in a cyclical manner, thereby producing rapidly expanding gases that drive linear movements of the piston, which are in turn converted into rotation of the crankshaft by the connecting rod.

The waste gases produced by the combustion of the fuel are emitted into the atmosphere via an exhaust gas system. Some of these waste gases include combustion byproducts, such as NOₓ, that are strictly regulated. One technique that is used to reduce these waste gas emissions is through exhaust gas recirculation (EGR), which typically involves recirculating a portion of the exhaust gas back into the intake air flowing into the engine cylinders. By recirculating exhaust gas back into the engine cylinders, the flame temperature in the engine may be reduced resulting in a decrease in the production of NOₓ in the exhaust gases.

In order to further reduce NOₓ production, EGR recirculation circuits may include an EGR cooler, which reduces the temperature of the exhaust gases before the exhaust gases are re-introduced into the intake air. The reduced temperature of the exhaust gases further reduces the flame temperature in the engine, thereby further lowering NOₓ production.

EGR coolers are prone to fouling, which reduces the thermal efficiency of the cooler, thereby impairing the ability of the cooler to reduce exhaust gas temperatures and, consequently, reduce harmful exhaust gas production.

Accordingly, it is desirable to provide an exhaust gas system in which fouling of EGR coolers is reduced. In addition, it is desirable that the exhaust gas system is re-usable and simple in design. Furthermore, other desirable features and characteristics of the present invention will become apparent from the subsequent detailed description and the appended claims, taken in conjunction with the accompanying drawings and the foregoing technical field and background.

### SUMMARY

An apparatus is provided for an internal combustion engine of a vehicle. The internal combustion engine includes an air intake pipe configured to direct flow of air to an internal combustion engine. The internal combustion engine also includes an exhaust gas system which includes an exhaust pipe configured to direct flow of an exhaust gas from the internal combustion engine. The exhaust gas system further includes an exhaust gas recirculation circuit configured to direct at least a portion of the flow of the exhaust gas from the exhaust pipe to the air intake pipe. The exhaust gas recirculation circuit includes an exhaust gas recirculation cooler. The internal combustion engine also includes a heat generator configured to supply heat to at least one of the air intake pipe, the exhaust gas recirculation circuit and the exhaust pipe. The heat generator includes a solution of reactants configured to chemically react, in an exothermic manner, in response to an external stimulus.

In an embodiment, the external stimulus includes a mechanical impulse.

In an embodiment, the exhaust gas system further includes an actuator configured to supply the mechanical impulse in reaction to an event associated with vehicle startup.

In an embodiment, wherein the exothermic chemical reaction between the reactants of the heat generator is a reversible reaction.

In an embodiment, one or more products of the exothermic chemical reaction react endothermically to form the solution of reactants, this endothermic reaction being stimulated by a temperature greater than an equilibrium temperature when the heated component reaches thermal equilibrium with the heat generator.

In an embodiment, the solution of reactants of the exothermic reaction includes an oversaturated solution of sodium acetate and water.

In an embodiment, the heat generator includes a wrapping having a thermally conductive material at a first surface location in contact with the heated component, and a thermally insulating material at a second surface location opposite the first surface location with the solution of reactants retained therebetween. The wrapping may be configured to surround at least a portion of the heated component, such that the generated heat flux from the exothermic reaction is directed toward the heated component.

In an embodiment, the internal combustion engine is a diesel engine and the predetermined temperature as acid dew point.

There is also herein provided a method for operating an internal combustion engine of a vehicle. The internal combustion engine includes an exhaust gas system and an air intake pipe configured to direct flow of air to the internal combustion engine. The exhaust gas system includes an exhaust pipe configured to direct flow of an exhaust gas from the internal combustion engine. The exhaust gas system further includes an exhaust gas recirculation circuit configured to direct at least a portion of the flow of the exhaust gas from the exhaust pipe to the air intake pipe. The exhaust gas recirculation circuit includes an exhaust gas recirculation cooler. In accordance with the method, a stimulus is generated at a time associated with an increased risk of condensation of exhaust gas constituents in the exhaust gas system. In response to the stimulus, heat is generated and supplied to at least one of the air intake pipe, the exhaust pipe, or the exhaust gas recirculation circuit.

In an embodiment, the step of generating a stimulus includes generating a mechanical impulse.

In an embodiment, the exothermic reaction is reversed after the heated component has reached thermal equilibrium with the heat generator.

In an embodiment, one or more products of the exothermic reaction react endothermically in a reversible manner to form the solution of reactants, the endothermic reaction being stimulated by a temperature higher than the equilibrium temperature, for example higher than the acid dew point of the exhaust gas.

In an embodiment, the solution of reactants includes an oversaturated solution of sodium acetate and water.

In an embodiment, the method further includes the step of thermally conducting heat from the heat generator through a heat-conductive material at a first surface location in contact with the heated component and thermally insulating heat from the heat generator with an insulating material at a second surface location opposite the first surface location, such that the heat flux from the heat generator is directed toward the heated component.

In an embodiment, the internal combustion engine is a diesel engine and the predetermined temperature is the acid dew point.

There is also herein provided a method for providing heat to a vehicle component in a cold condition, the method comprising generating a stimulus in response to an event associated with vehicle start-up for initiating an exothermic reaction of a solution of reactants in a heat generator, and, in response to the stimulus, and supplying heat to the vehicle component from the heat generator.

In an embodiment, the method further includes the step of reversing the exothermic reaction after the heated component has reached the equilibrium temperature.

In an embodiment, a product of the exothermic reaction is configured to react endothermically in a reversible manner to form the solution of reactants, the endothermic reaction being stimulated by a temperature higher than the equilibrium temperature.

In an embodiment, the solution of reactants comprises an oversaturated solution of sodium acetate and water.

### DESCRIPTION OF THE DRAWINGS

The exemplary embodiments will hereinafter be described in conjunction with the following drawing figures, wherein like numerals denote like elements.

FIG. 1 is a side view of a vehicle with an exhaust gas system of the present disclosure;

FIG. 2A is a schematic view of an internal combustion engine and an exhaust gas system according to example embodiments;

FIG. 2B is a schematic of an internal combustion engine and another exhaust gas system according to example embodiments;

FIG. 3A is an exemplary illustration of a heat generator according to example embodiments;

FIG. 3B shows a cross section through line B-B shown in FIG. 3A;

FIG. 4 is a graph showing the temperature increase with respect to time of an exothermic reaction that may be used in the heat generator of example embodiments;

FIG. 5 is a flowchart illustrating a method of operating the exhaust gas system of the present disclosure according to example embodiments; and

FIG. 6 is a flowchart illustrating another method of the present disclosure according to example embodiments.

### DETAILED DESCRIPTION

The following detailed description is merely exemplary in nature and is not intended to limit the invention disclosed herein or the application and uses of the invention disclosed herein. Furthermore, there is no intention to be bound by any principle or theory, whether expressed or implied, presented in the preceding technical field, background, summary or the following detailed description, unless explicitly recited as claimed subject matter.

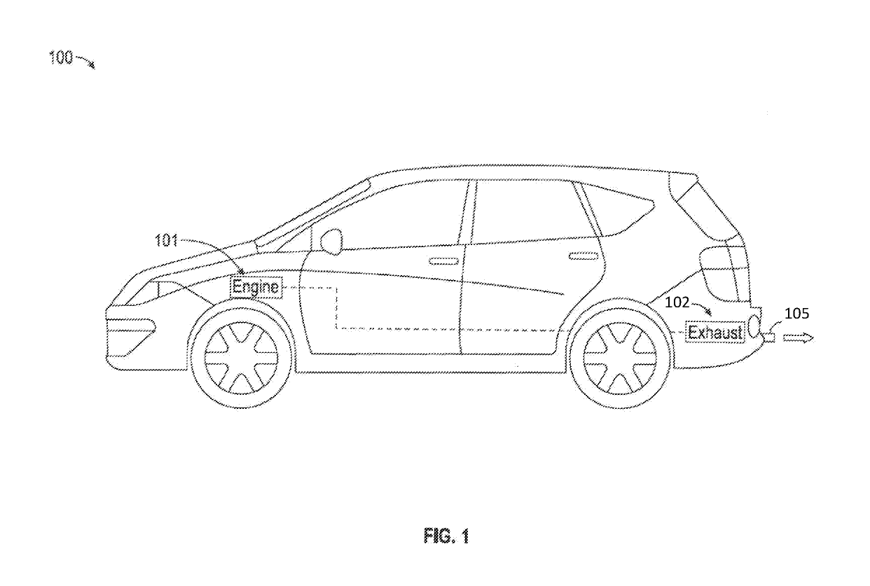

Embodiments of the present disclosure may include a motor vehicle 100 as shown in FIG. 1. As shown in FIG. 1, the vehicle 100 includes an internal combustion engine 101, an exhaust gas system 102 and an exhaust pipe 105.

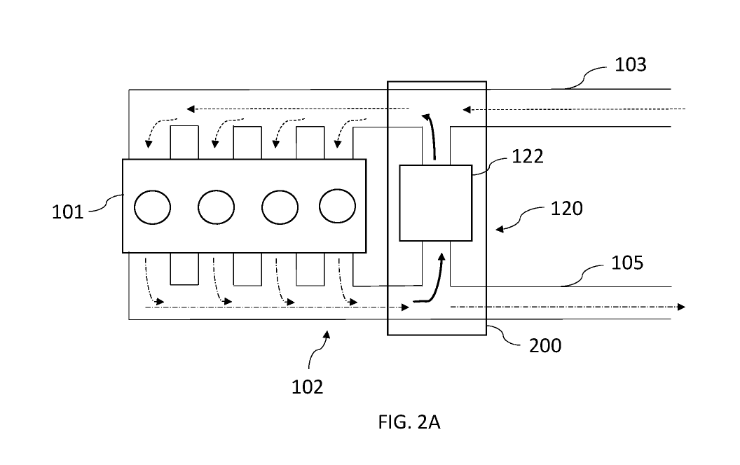

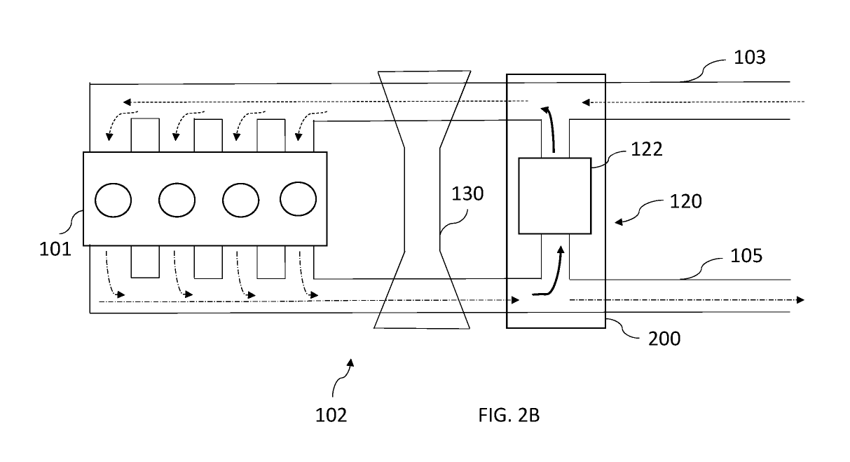

As shown in the schematic of FIG. 2A, the engine 101 may include one or more cylinders. Each cylinder includes a piston. The piston may include a linkage with which a crankshaft is turned. A cylinder head cooperates with the piston to define a combustion chamber. Air (shown by short dashed lines) is received via the air intake 103 and mixed with fuel. The mixture of air and fuel is introduced into the combustion chambers of the engine 101 and ignited, resulting in hot, expanding combustion gases which cause the piston to move linearly within the cylinder, thereby turning the crankshaft.

After ignition, the waste combustion gases (shown by long dashed dot lines) are expelled from the cylinder and flow into an exhaust pipe 105 that is configured to direct the flow of the exhaust gases away from the engine 101. The exhaust pipe 105 may have one end that is open to the atmosphere in order to vent these gases to the atmosphere.

In order to reduce harmful exhaust gas emissions, such as NOₓ, the exhaust gas system 102 may include an exhaust gas recirculation circuit 120. The exhaust gas recirculation circuit 120 may be configured to direct at least some of the exhaust gas (shown by the thick solid lines) from the exhaust pipe 105 to the air intake 103. By directing a portion of the exhaust gas from the exhaust pipe 105 via the exhaust gas recirculation circuit 120 to the air intake, the amount of air available for combustion is reduced, since a portion of the air that would otherwise be available for combustion is replaced with exhaust gas.

Due to the reduction in the amount of air available for combustion, the flame temperature in the engine cylinders may be reduced. The reduction of the flame temperature may reduce NOₓ production during ignition in the cylinder.

As shown in FIG. 2A, in order to further reduce NOₓ production, exhaust gas may be redirected via an exhaust gas recirculation unit 120. During recirculation, the exhaust gas may be cooled via an exhaust gas recirculation (EGR) cooler 122 as the exhaust gas flows through this exhaust gas recirculation circuit 120.

The EGR cooler 122 may be a dedicated cooler, for example a dedicated heat exchanger; dedicated “shell and tube”-type cooler; or dedicated “stack”-type cooler.

The EGR cooler 122 may be prone to fouling. Specifically, the EGR cooler may become fouled due to the condensation of exhaust gases inside the EGR cooler 122. The present inventor observed that droplet formation due to condensation may occur inside the EGR cooler at exhaust gas temperatures below a predetermined temperature. In an exhaust gas recirculation system for a diesel engine, the predetermined temperature may be the acid dew point of the combustion end products or exhaust gas. Exhaust gas condensation in the EGR cooler 122 also decreases the efficiency of heat transfer between the exhaust gas and the EGR cooler 122.

Condensation fouling of EGR coolers is commonly encountered in diesel engines, due to the lower exhaust gas temperatures of diesel engines at vehicle start-up. It has been observed that condensation of hydrocarbons and other exhaust gas particles may commonly occur in EGR coolers of diesel engines at vehicle start-up, since exhaust gas temperatures of below the acid dew point are commonly encountered at, or shortly after, vehicle startup. The term “vehicle startup” as used herein describes the time period between starting the engine 101 (where the engine temperature may be approximately equal to ambient temperature) and a time where the engine temperature and exhaust gas component temperature is higher than the acid dew point.

Furthermore, condensation fouling may also problematically occur elsewhere in the exhaust gas system 102. For example, if the vehicle includes a turbocharger, exhaust gases may be routed toward the “cold” inlet side of the compressor wheel of the turbocharger. In this configuration, exhaust gas condensation around the compressor wheel may negatively affect the structural integrity of the compressor wheel.

In embodiments, a heat generator 200 is provided to supply heat to the exhaust gas system 102 at vehicle startup. By supplying heat to the exhaust gas system 102 at vehicle startup, the temperature of the exhaust gas is increased. In vehicles with EGR recirculation circuits 120, an increased temperature of the exhaust gas allows for a reduction in the amount of condensation of the exhaust gas inside the EGR cooler 122 that would otherwise occur at vehicle startup. In some embodiments, the vehicle may include a control system that is configured to selectively determine whether or not to allow exhaust gas to flow through an EGR recirculation circuit, depending on the temperature of the exhaust gas, in order to reduce condensation inside the EGR cooler 122. In these embodiments, the heat generator 200 would allow for earlier use of the EGR recirculation circuit after vehicle startup.

In some embodiments, the heat generator 200 may also be configured to supply heat to the exhaust gas system 102 at times other than at vehicle startup. For example, the heat generator 200 may be operatively linked to a temperature sensor, such as a thermometer or thermocouple. The heat generator may be controlled via a processor to supply heat to the exhaust gas system 102 if the temperature of the engine drops below a predetermined temperature such as the acid dew point of the exhaust gas. One skilled in the art should recognize that the acid dew point depends upon the composition of the specific fuel being burned and the resultant exhaust gas composition as well as the pressure and temperature of the exhaust gases. Thus, these parameters may be used to approximate the acid dew point for a given operating state.

In various embodiments, the heat generator 200 may supply heat to more than one component of the exhaust gas system 102 and/or air intake 103. In other embodiments, the heat generator 200 may supply heat to only one component of the exhaust gas system 102 or the air intake 103.

In one embodiment, the heat generator 200 may supply heat to the exhaust pipe 105. As explained above, supplying heat to the exhaust pipe warms the exhaust gas so that less condensation of exhaust gas occurs inside the exhaust gas system 102 during vehicle startup, or so that the EGR recirculation circuit 120 may be used more quickly after vehicle startup.

In an embodiment, the heat generator 200 may additionally or alternatively supply heat to the exhaust gas recirculation circuit 120. For example, if the exhaust gas recirculation circuit comprises a series of thin pipes and an EGR cooler 122, the heat generator 200 may supply heat to either the pipes, the EGR cooler 122, or both the pipes and the EGR cooler 122. Supplying heat to the exhaust gas recirculation circuit 120 heats the recirculated exhaust gas such that less condensation of the exhaust gas occurs inside the EGR cooler 122 during vehicle startup. Furthermore, the pipes of the exhaust gas recirculation circuit 120 are generally smaller in diameter and have multiple bends. These pipes therefore normally have one of the highest thermal inertia values of the exhaust gas system 102, and consequently take the longest time to reach thermal equilibrium with the surrounding atmosphere. As such, supplying heat from the heat generator to the exhaust recirculation circuit pipes may be beneficial in order to compensate for this high level of thermal inertia.

In another embodiment, the heat generator 200 may additionally or alternatively supply heat to the air intake pipe 103. In this embodiment, the heat generator 200 may allow for the reduction of the corrosion caused by condensation of exhaust gas on other vehicle components. For example, as shown in FIG. 2B, a turbocharger 130 may be disposed in both the exhaust gas flow and the air intake flow. The compressor wheel of the turbocharger disposed in the air intake flow may become corroded due to droplet condensation of recirculated exhaust gas in the air intake pipe 103. With the heat generator 200 supplying heat to the air intake pipe 103, the amount of condensation of recirculated exhaust gas in the air intake pipe 103 may be reduced, and the amount of corrosion to the compressor wheel of the turbocharger 130 may accordingly be reduced.

Still further, the use of a heat generator 200 to supply heat to the exhaust gas system 102 in the manner described above may also allow for the use of the EGR recirculation unit before vehicle start-up.

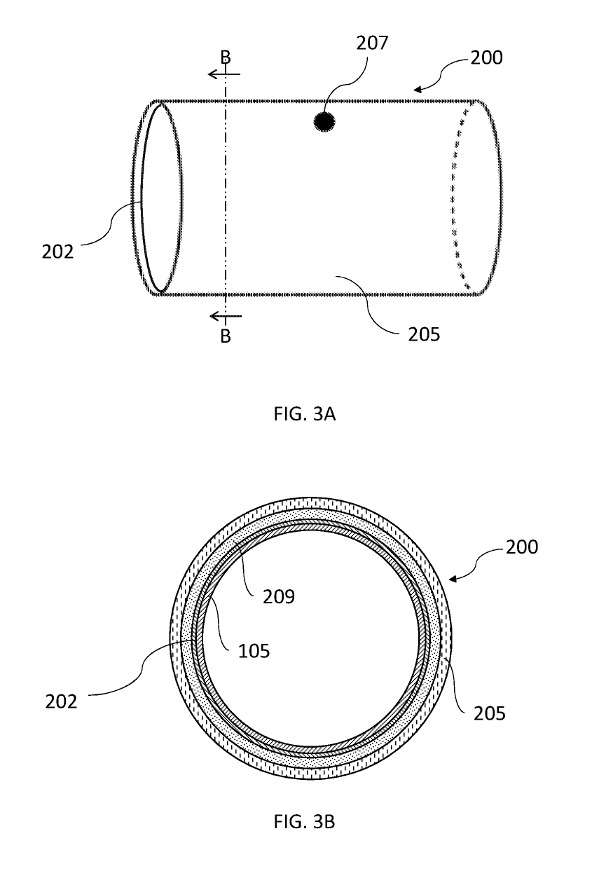

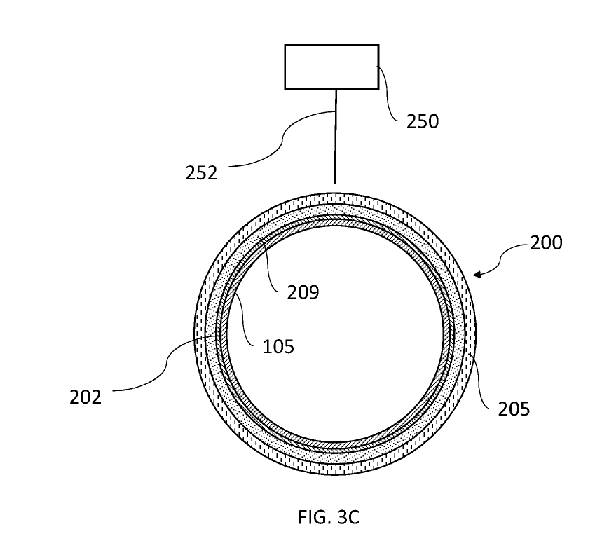

An exemplary heat generator 200 is shown in FIG. 3. The heat generator 200 may have a cylindrical form, such that the heat generator can be wrapped around the air intake pipe 103, the pipes and/or EGR cooler 122 of the exhaust gas recirculation circuit 120, and/or the exhaust pipe 105.

The heat generator 200 may be flexible or have a relatively non-flexible form. Preferably, the heat generator 200 comprises a textile wrapping which may be wrapped around various components of the exhaust gas system 102.

The heat generator 200 is preferably thermally conductive at surface locations 202 which are in contact with the component of the exhaust gas system to which the heat generator 200 is supplying heat. Furthermore, the heat generator 200 is preferably thermally insulating at surface locations 205 which are not in contact with the component of the exhaust gas system to which the heat generator is supplying heat. One example of such a configuration would be a wrapping incorporating stainless steel on its “inner” surface 202 (which surface is to be placed into contact with the vehicle component to which heat will be supplied) and woven fiberglass fabric on its “outer” surface 205 (which surface is not placed into contact with the vehicle component to which heat is supplied). In this manner, most of the heat generated by the heat generator 200 will be directed through the inner surface 202 to the component of the exhaust gas system 102, with the amount of heat lost to the atmosphere through the outer surface 205 reduced.

Preferably, the mechanism of heat generation is a chemical exothermic reaction of reactants in a solution 209 that are contained within the heat generator 200. A chemical exothermic reaction allows for heat to be generated with minimal fuel or battery use, and a simple mechanism may be used to initiate the chemical reaction. The exothermic reaction may have a relatively slow rate of reaction, such that heat is generated over a relatively long period of time.

The exothermic reaction may occur in response to an external stimulus. The stimulus may be heat-based, such as increasing the temperature of a mixture of reactants to a certain temperature at which the reaction will occur. In some embodiments, the stimulus is a mechanical stimulus, such as a mechanical impulse to the mixture of reactants. A simple, reliable mechanical actuator 207 (such as a solid ball) may be used to deliver a mechanical impulse to the reactants contained in the heat generator 200.

The stimulus may be affected in response to a user-initiated action associated with vehicle start-up. This action may be mechanical in nature. For example, the action may be effected by an actuator configured to impart a mechanical impulse to the heat generator 200 in reaction to one or more of: a user opening a vehicle door; a user exerting weight or pressure on the driver seat; a user inserting a key into the vehicle ignition; a user turning a key in the vehicle ignition; the movement of a vehicle control mechanism such as the brake, accelerator or clutch pedals; or the rotation of the engine crankshaft. In one embodiment, a ball disposed inside a mixture of chemical reactants may be subjected to an external impulse in response to the engine cranking, thereby delivering an impulse to the mixture of reactants. This would allow for a simple, compact configuration to allow for an impulse to be delivered to the reactants. In another embodiment, pressure on the seat causes movement of an impulse rod, which rod impacts the heat generator 200 in order to deliver an impulse to the heat generator 200 to thereby initiate the exothermic reaction.

Additionally or alternatively, the action may be electrical in nature, such as the automated unlocking of the vehicle doors. For example, a signal emitted by a driver's key fob to unlock the vehicle's doors may trigger a piezoelectric actuator to deliver a mechanical impulse to the mixture of reactants in to stimulate the exothermic reaction.

Preferably, the exothermic reaction is reversible, such that the product(s) of the chemical reaction may react to re-form the reactants of the reaction. Preferably, the reverse reaction occurs in response to the temperature of the environment around the product(s) exceeding the dew point. In other words, the product(s) of the exothermic reaction would revert back to the reactants at an environmental temperature exceeding the dew point. This reverse reaction may be a phase change, such as melting. The product(s) of the exothermic reaction may also be in the form of a solution.

With a reversible reaction of this type, the heat generator 200 is re-usable. In other words, the heat generator 200 may heat a vehicle component during the colder conditions associated with vehicle start-up via an exothermic reaction, and then react endothermically when the temperature of the engine increases after vehicle start-up such that the products of the exothermic reaction react to form the reactants of the exothermic reaction. This would allow for the same heat generator 200 to be re-used to heat a vehicle component during a subsequent vehicle start-up procedure.

In other words, the heat generator 200 may generate heat through an exothermic reaction when the temperature of the exhaust gas recirculation circuit is below the dew point and exhaust gases are therefore prone to condensing inside the EGR cooler 122. Then, after vehicle startup, when the engine block 101 increases in temperature such that the exhaust gas recirculation circuit 120 is operating at a temperature above the product(s) melting point and exhaust gases are therefore less prone to condensing in the EGR cooler 122, the higher temperature stimulates the endothermic reaction (which is the reverse of the initial exothermic reaction) such that the product(s) of the exothermic reaction are converted back into the reactants. As such, the heat generator 200 may subsequently be re-used to heat the exhaust gas recirculation circuit 120 at the subsequent vehicle start-up procedure.

The preferred reactants for the exothermic reaction are sodium acetate and water and more particularly an oversaturated solution 209 of sodium acetate and water. Sodium acetate reacts reversibly with water exothermically to form crystals in the following manner:

CH₃COONα_{(aq)}+3H₂O₍ₗ₎↔CH₃COONα·3H₂O₍ₛ₎

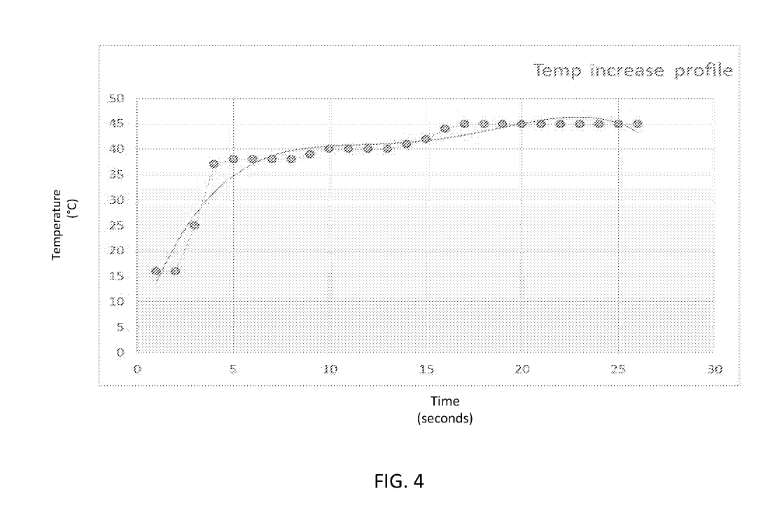

As can be seen in the graph of FIG. 4, the exothermic reaction of sodium acetate with water can result of a temperature increase of over 20° C. in around 4 seconds. Furthermore, as can be seen in this graph, the reaction continues to output heat for a relatively long time after the initial heat increase.

As described above, this activation energy may be supplied via a mechanical impulse.

Supplying the activation energy to stimulate the exothermic reaction though a mechanical impulse has multiple benefits. No fuel usage is needed to supply this activation energy, and a simple mechanism may be used to provide this activation energy.

In the above reaction of sodium acetate with water, the crystal formation of sodium acetate with water may result in a volume expansion of around 13%.

In order to accommodate this volume expansion associated with crystal formation, the heat generator 200 may not be completely filled with the mixture of sodium acetate and water, such that there is spare volume into which the solid crystals may expand. Additionally or alternatively, the material of the heat generator 200 may be elastically deformable, such that the material may “stretch” to accommodate the volume expansion associated with crystal formation.

Referring now to FIG. 5, a method 300 of operating the exhaust gas system 120 is illustrated according to exemplary embodiments. The method 300 begins at 302, indicating that an event associated with vehicle start-up has occurred. As detailed above, the event associated with vehicle start-up may include a door of the vehicle opening, weight or pressure being exerted on the driver seat, a key being inserted into the vehicle ignition, a vehicle pedal being pressed, or the engine cranking.

At 304, a stimulus is generated in response to the event. The generation of the stimulus may be performed via detection of the event using a sensor and then mechanically or electrically generating the stimulus. Alternatively, the generation of the stimulus may be performed via simple mechanical actuation of a mechanism 207 linked with the event, such as a metal ball disposed inside the heat generator being impulsed in response to the engine cranking.

At 306, heat is generated by the exothermic reaction of the solution 209 in response to the stimulus. The heat is generated through an exothermic chemical reaction. At 308, the heat is supplied to a component of the vehicle exhaust gas system (which may be at least one of the air intake pipe 103, the exhaust pipe 105, or the exhaust gas recirculation unit 120) to heat this component. Subsequently, the method 300 may terminate at 310 when the temperature of the heated component (e.g., air intake 102, exhaust pipe 105, or EGR cooler 220) is higher than an equilibrium temperature when the heated component and the heat generator are in thermal equilibrium, which is above the melting point of the product(s) of the exothermic reaction causing a reverse endothermic reaction of the solution 209 into an oversaturated solution of sodium acetate and water.

In alternative embodiments, the exothermic reaction of the heat generator may be used for other purposes aside from heating components of an EGR recirculation unit. For example, the exothermic reaction may be used to supply heat to other vehicle components (such as the driving wheel, the vehicle's seats, or the cabin heater) at vehicle startup without negatively impacting vehicle fuel economy. In embodiments, the exothermic reaction may be reversible, such that the heat generator 200 may be subsequently re-used in the same manner as described above.

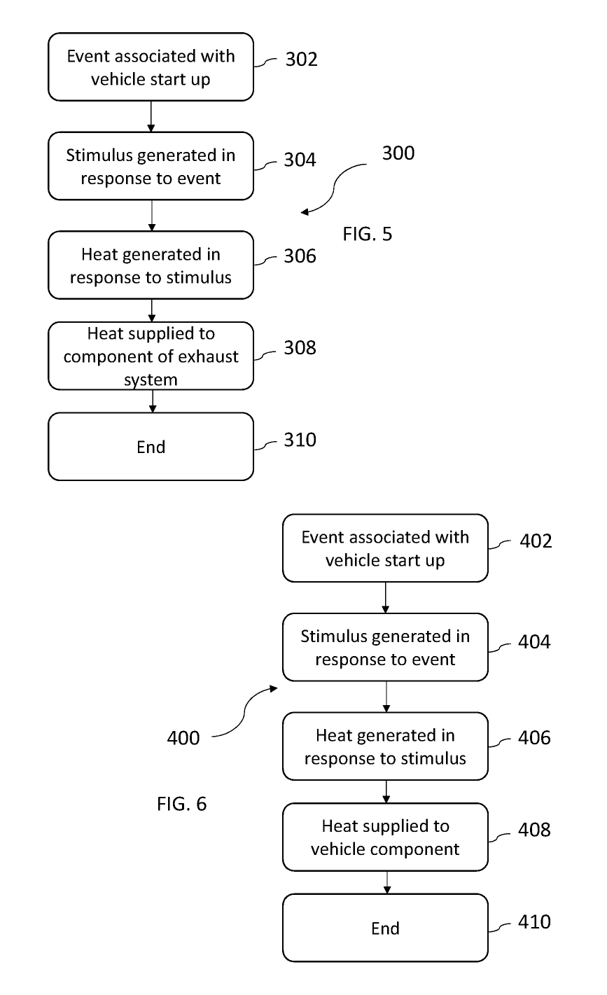

Referring to FIG. 6, a method 400 for providing heat to a vehicle component in cold conditions. The method 400 may begin at 402, indicating that an event associated with vehicle start-up has occurred. As detailed above, the event associated with vehicle start-up may include a door of the vehicle opening, weight or pressure being exerted on the driver seat, a key being inserted into the vehicle ignition, a vehicle pedal being pressed, or the engine cranking.

At 404, a stimulus is generated in response to the event. The generation of the stimulus may be performed via detection of the event using a sensor and then mechanically or electrically generating the stimulus. Alternatively, the generation of the stimulus may be performed via simple mechanical actuation of a mechanism 207 linked with the event, such as a metal ball disposed inside the heat generator being impulsed in response to the engine cranking. At 406, heat is generated by the solution 209 in response to the stimulus. The heat may be generated by a thermocouple. Preferably, however, the heat is generated through an exothermic chemical reaction. At 408, the heat is supplied to a vehicle component (which may be the driving wheel, the vehicle seats, or the cabin heater) in order to heat this component. The method 400 may then terminate at 410 when the heated component (e.g., air intake 102, exhaust pipe 105, or EGR cooler 220) is above the product(s) melting point, thereby causing a reverse endothermic reaction of the solution 209 into an oversaturate solution of sodium acetate and water.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

1. A vehicle comprising:
a seat coupled to an impulse rod, the impulse rod movable to deliver an impulse to a heat generator based on a pressure applied to the seat;
an air intake pipe configured to direct flow of air to an internal combustion engine;
an exhaust pipe configured to direct flow of an exhaust gas from the internal combustion engine;
an exhaust gas recirculation circuit configured to direct at least a portion of the flow of the exhaust gas from the exhaust pipe to the air intake pipe, the exhaust gas recirculation circuit comprising an exhaust gas recirculation cooler; and
the heat generator configured to supply heat to a heated component selected from the group consisting of the air intake pipe, the exhaust gas recirculation circuit, the exhaust pipe or a combination thereof, the heat generator is a textile wrapping having a conductive material on an inner surface in contact with the heated component and an insulating material on an opposite outer surface, with a solution of reactants contained between the inner surface and the outer surface, the solution of reactants configured to react exothermically in response to the impulse from the impulse rod to form one or more products of the exothermic reaction.

2.-3. (canceled)

4. The vehicle of claim 1, wherein the exothermic reaction is a reversible reaction.

5. The vehicle of claim 4, wherein the one or more products of the exothermic reaction are configured to react endothermically to form the reactants, the endothermic reaction being stimulated by a temperature greater than an equilibrium temperature when the heated component and the heat generator are in thermal equilibrium.

6. (canceled)

7. The vehicle of claim 5, wherein the solution of reactants of the exothermic reaction comprises an oversaturated solution of sodium acetate and water.

8. (canceled)

9. The vehicle of claim 1, wherein the internal combustion engine is a diesel engine.

10. A method for operating an internal combustion engine of a vehicle having an air intake pipe configured to direct flow of air to the internal combustion engine, an exhaust pipe configured to direct flow of an exhaust gas from the internal combustion engine, and an exhaust gas recirculation circuit configured to direct at least a portion of the flow of the exhaust gas from the exhaust pipe to the air intake pipe, the method comprising:
moving an impulse rod coupled to a seat of the vehicle based on pressure received on the seat to deliver an impulse to a heat generator;
delivering the impulse to the heat generator from the impulse rod to initiate an exothermic reaction of a solution of reactants in the heat generator, the heat generator is a textile wrapping having a conductive material on an inner surface and an insulating material on an opposite outer surface, with a solution of reactants contained between the inner surface and the outer surface; and
supplying heat from the heat generator to a heated component in contact with the inner surface of the heat generator, the heated component selected from the group consisting of the air intake pipe, the exhaust pipe, the exhaust gas recirculation circuit or a combination thereof in response to the stimulus.

11. (canceled)

12. The method of claim 9, further comprising reversing the exothermic reaction after the heated component has reached an equilibrium temperature when the heated component and the heat generator are in thermal equilibrium.

13. The method of claim 12, wherein one or more products of the exothermic reaction react endothermically to form the solution of reactants, the endothermic reaction being stimulated by a temperature higher than the equilibrium temperature.

14. The method of claim 9, wherein the solution of reactants comprises an oversaturated solution of sodium acetate and water.

15. (canceled)

16. The method of claim 9, wherein the internal combustion engine is a diesel engine.

17. A method for providing heat to a vehicle component in a cold condition, the method comprising:
generating an external impulse to a ball disposed inside of a heat generator in response to an event associated with vehicle start-up to deliver an impulse for initiating an exothermic reaction of a solution of reactants in the heat generator; and
in response to the stimulus, supplying heat to the vehicle component from the heat generator, the heat generator is a textile wrapping having a conductive material on an inner surface in contact with the vehicle component and an insulating material on an opposite outer surface, with a solution of reactants contained between the inner surface and the outer surface and the ball is disposed inside of the solution of reactants to deliver the impulse to the solution of reactants.

18. The method of claim 16, further comprising reversing the exothermic reaction after the heated component has reached a target temperature.

19. The method of claim 17, wherein a product of the exothermic reaction is configured to react endothermically to form the solution of reactants, the endothermic reaction being stimulated by a temperature higher than a predetermined temperature.

20. The method of claim 16, wherein the solution of reactants comprises an oversaturated solution of sodium acetate and water.
